(19) United States
(12) Patent Application Publication
(10) Pub. No.: US 2024/0368450 A1
(43) Pub. Date: Nov. 7, 2024

(54) GEOPOLYMER MATERIAL, AND PREPARATION METHOD THEREFOR AND USE THEREOF

(71) Applicants: CHINA PETROLEUM & CHEMICAL CORPORATION, Beijing (CN); SINOPEC PETROLEUM ENGINEERING TECHNOLOGY RESEARCH INSTITUTE CO., LTD, Beijing (CN)

(72) Inventors: Shiming ZHOU, Beijing (CN); Haoguang WEI, Beijing (CN); Haoya LIU, Beijing (CN); Xiaojiang LI, Beijing (CN); Mu WANG, Beijing (CN); Chunqin TAN, Beijing (CN); Xia MIAO, Beijing (CN)

(21) Appl. No.: 18/681,063

(22) PCT Filed: Jul. 20, 2022
(86) PCT No.: PCT/CN2022/106761

§ 371 Date: Feb. 4, 2024

(30) Foreign Application Priority Data
Aug. 18, 2021 (CN) 202110947865.9

(51) Int. Cl. C09K 8/46; C04B 14/04; C04B 22/06; C04B 22/16; C04B 28/00; C04B 40/00; C04B 103/10; E21B 33/13

(52) U.S. Cl. CPC C09K 8/46; C04B 14/045; C04B 22/062; C04B 22/16; C04B 28/006; C04B 40/0082; E21B 33/13; C04B 2103/10

(57) ABSTRACT

A geopolymer material, and a preparation method therefor and the use thereof are provided. The geopolymer material contains modified siallite. On the basis of the total amount of the modified siallite and in terms of oxide, the aluminum content in the modified siallite is 35 weight % or more, and the silicon content is 40 weight % or more. The initial setting time of the geopolymer material is at least one temperature in the range of 70-300° C. is 5-10 hours, and the final setting time is 7-12 hours. The geopolymer material has an appropriate initial setting time and final setting time when activated by an activator, and can achieve well cementation at a higher temperature even when a retarder is not used in cooperation.

### CROSS REFERENCE TO RELATED APPLICATIONS

The application claims the benefit of the Chinese patent application No. “202110947865.9”, filed on Aug. 18, 2021, the contents of which are entirely incorporated herein by reference.

### TECHNICAL FIELD

The present disclosure belongs to the technical field of geopolymer, in particular relates to a geopolymer material and a preparation method therefor and a use thereof.

### BACKGROUND ART

The concept of geopolymer was proposed by the French professor Davidovits in 1978, it was a three-dimensional, network-structured, alumino-silica cementitious material consisting of the structural units [SiO₄]⁴⁻ and [AlO₄]⁵⁻ derived from the alkali-activated alumino-silicate materials (e.g., metakaolin) under the action of an alkali-activator. The geopolymer material provides considerable advantages over the other commonly used hydraulic material in the aspects that it can reduce energy consumption by more than 70% compared to the conventional cements, reduces carbon emissions by more than 80%, and does not emit sulfur oxides and nitrogen oxides, thus the geopolymer material is also known as “green cement”, the three-dimensional network structure of the geopolymer material allows that the material has a range of excellent physicochemical properties, such as high temperature stability, mechanical properties, corrosion resistance and durability, thus the geopolymer material is unconventional cementitious materials with great potential, it exhibits the possibility of replacing the conventional Portland cements. As a result, the geopolymer has attracted more and more attention from the science researchers.

However, despite the geopolymer has superior physicochemical properties to the Portland cement, the excessively rapid curing speed of the geopolymer is the greatest obstacle to hinder its application. The geopolymer requires an action of strong alkali to perform its desirable function, but the material has a short setting time (a setting time less than 0.5 h under the action of a retarder and the temperature of 80° C.) and do not meet the requirements of operation and construction, thereby severely hinder its promotion and use, especially in oilfield cementing engineering.

The current researches in this aspect have been focused on selecting high-performance geopolymer retarder thereby control the curing time of geopolymer. CN201910426647.3 discloses an adaptive retarder for the geoplymer, which is formed by compounding potassium dihydrogen phosphate in an amount of 30-40 wt %, borax in an amount of 30-50 wt % and calcium chloride in an amount of 20-30 wt %. CN201810851330.X discloses a use of the lignosulfonate type water reducing agent and the phosphate retarder to provide the concrete with desirable working performance. CN201810770099.1 discloses a saccharides geopolymer retarder, comprising 0%-80% of saccharides, 0%-80% of saccharide alcohols and 10%-90% of water. In addition, the literature “Effect of Different Admixtures on the Setting and Hardening Properties of Geopolymer” proposes a use of boric acid for controlling retarding and fluidity of slag powder-based geopolymers, the experiments demonstrate that along with the increased doping amount within a doping range of 0-4%, the setting time of geopolymers increases considerably, the loss of fluidity over time is decreased, and the compressive strength increases slightly.

However, each of the aforementioned patents and literature controls the curing time of a geopolymer material by adding admixtures into the geopolymer material, the method has a limited applicable temperature range, the addition of admixtures will necessarily increase costs and operational complexity. Therefore, it is urgently required to research and develop a novel method for controlling the curing time of geopolymers and the corresponding geopolymers.

### SUMMARY

The current technologies adopted by the oil and gas well cementation industry have obvious limitations in the aspects such as improving the high temperature stability, mechanical properties, corrosion resistance and durability of the conventional Portland cement materials. Although the geopolymer offers significant advantages in the aspects, its curing time is excessively short, the curing time can be optimized to some extent by adding admixtures, the adding operation will increase costs and operational complexity, the optimization potency of the curing time and its stability are limited.

In order to address the aforementioned problems of the well cementation technologies, the present disclosure provides a geopolymer material having suitable curing properties and a preparation method therefor and a use thereof. The geopolymer material of the present disclosure has an appropriate initial setting time and final setting time under the activation of an activator, and can achieve well cementation at a higher temperature even without a retarder. The curing time (also known as setting time) of the geopolymer material is controllable within a range of 5-10 hours by adjusting the type and ratio of geopolymers having different activities in the geopolymer material, such that the geopolymer material of the present disclosure can take performance advantages of geopolymer material while overcoming the hazards caused by its excessively rapid curing speed.

In order to achieve the above objects, a first aspect of the present disclosure provides a geopolymer material comprising a modified siallite, the modified siallite has an aluminium content of 35 wt % or more and a silicon content of 40 wt % or more, on the basis of the total amount of the modified siallite and in terms of oxide; the geopolymer material has an initial setting time of 5-10 hours and a final setting time of 7-12 hours under at least one temperature within a range of 70-300° C.

Preferably, the geopolymer material has an initial setting time of 5-10 hours and a final setting time of 7-12 hours under at least one temperature within the ranges of 70-100° C., 100-150° C., 150-200° C., 200-250° C., or 250-300° C.

Preferably, a difference value between the final setting time and the initial setting time of the geopolymer material is within a range of 1-5 hours.

Preferably, the geopolymer material does not contain a retarder, the retarder is one or more selected from the group consisting of lignosulfonate and derivatives thereof, saccharides and derivatives thereof, boric acid and salts thereof, phosphoric acid and salts thereof, phosphonic acid and salts thereof, acrylic polymer, citric acid and salts thereof, tartaric acid and salts thereof, zinc salts, alkaline-earth metal salts and inorganic sulphate salts.

Preferably, the content of modified siallite in the geopolymer material is 55 wt % or more, more preferably 55-80 wt %.

Preferably, an XRD spectrogram of the geopolymer material illustrates a crystalline characteristic peak and an amorphous characteristic peak when 2θ is within a range of 15-30 °.

Preferably, the geopolymer material has a Si dissolution ratio greater than 0.2, more preferably within a range of 0.5-1, further preferably within a range of 0.5-0.8.

Preferably, the geopolymer material comprises at least two of a first geopolymer, a second geopolymer, a third geopolymer and a fourth geopolymer; wherein the first geopolymer has an initial setting time of 32 hours or more or cannot be measured, and a final setting time cannot be measured; the second geopolymer has an initial setting time of 25 hours or more and less than 32 hours, and a final setting time of 60 hours or more or cannot be measured; the third geopolymer has an initial setting time of 8 hours or more and less than 25 hours, and a final setting time of 15 hours or more and less than 60 hours; the fourth geopolymer has an initial setting time of 2.5 hours or more and less than 8 hours, and a final setting time of 3 hours or more and less than 15 hours, under the activation conditions consisting of using an aqueous solution comprising sodium hydroxide in an amount of 4 mol/L and sodium silicate in an amount of 3 mol/L as an activator at 50° C., with a weight ratio of the activator and the geopolymer material being 0.5.

Preferably, the first geopolymer, the second geopolymer, the third geopolymer and the fourth geopolymer are kaolin calcined at different temperatures, respectively.

Preferably, the calcination temperatures of geopolymers are as follows:
the calcination temperature of the first geopolymer is not higher than 600° C. or higher than 950° C.;
the calcination temperature of the second geopolymer is above 600° C. and not higher than 650° C., or above 850° C. and not higher than 950° C.;
the calcination temperature of the third geopolymer is above 650° C. and not higher than 700° C., or above 750° C. and not higher than 850° C.;
the calcination temperature of the fourth geopolymer is above 700° C. and not higher than 750° C.;

preferably, the calcination time is within a range of 1.5-2.5 hours, preferably 1.8-2.2 hours.

Preferably, the geopolymer material comprises any one of the following geopolymers in terms of parts by weight:
(1) 70-80 parts of a third geopolymer and 70-80 parts of a fourth geopolymer;
(2) 40-60 parts of a second geopolymer, 90-110 parts of a third geopolymer, and 8-12 parts of a fourth geopolymer;
(3) 40-60 parts of a first geopolymer and 90-110 parts of a third geopolymer;
(4) 40-60 parts of a second geopolymer and 70-90 parts of a third geopolymer;
(5) 90-110 parts of a first geopolymer and 8-12 parts of a third geopolymer;
(6) 90-110 parts of a second geopolymer and 15-25 parts of a third geopolymer;
(7) 40-60 parts by weight of a second geopolymer and 90-110 parts by weight of a third geopolymer;
(8) 40-60 parts by weight of a first geopolymer and 90-110 parts by weight of a fourth geopolymer.

Preferably, the geopolymer material further comprises an activator comprising one or more selected from the group consisting of a soluble hydroxide, a soluble silicate, a soluble carbonate and a soluble polyphosphate, more preferably one or more selected from the group consisting of sodium hydroxide, potassium hydroxide, sodium silicate, potassium silicate, sodium carbonate, potassium carbonate, sodium polyphosphate and potassium polyphosphate, further preferably comprising sodium hydroxide and sodium silicate, or sodium silicate and sodium polyphosphate; the activator and the modified siallite are stored separately and mixed when in use.

Preferably, the activator in a form of aqueous solution with a concentration of 0.5-10 mol/L is mixed with modified siallite; more preferably, the solution of the activator comprises a soluble hydroxide with a concentration of 2-6 mol/L, preferably 3-5 mol/L; and/or a soluble silicate with a concentration of 1-6 mol/L, preferably 2-4 mol/L; and/or a soluble polyphosphate with a concentration of 3-7 mol/L, preferably 4-6 mol/L.

Preferably, a weight ratio of the solution of activator to the modified siallite is within a range of 0.3-0.8, more preferably 0.4-0.6.

A second aspect of the present disclosure provides a method of preparing a geopolymer material comprising the step of preparing a geopolymer material by calcining kaolin at different temperatures to obtain at least two modified siallites, respectively, and then mixing the obtained at least two modified siallites.

Preferably, the at least two modified siallites are at least two of a first geopolymer, a second geopolymer, a third geopolymer and a fourth geopolymer; wherein the calcination temperatures of geopolymers are as follows:
the calcination temperature of the first geopolymer is not higher than 600° C. or higher than 950° C.;
the calcination temperature of the second geopolymer is above 600° C. and not higher than 650° C., or above 850° C. and not higher than 950° C.;
the calcination temperature of the third geopolymer is above 650° C. and not higher than 700° C., or above 750° C. and not higher than 850° C.;
the calcination temperature of the fourth geopolymer is above 700° C. and not higher than 750° C.

Preferably, the calcination time is within a range of 1.5-2.5 hours, preferably 1.8-2.2 hours.

Preferably, the method does not include a step of adding a retarder, the retarder is one or more selected from the group consisting of lignosulfonate and derivatives thereof, saccharides and derivatives thereof, boric acid and salts thereof, phosphoric acid and salts thereof, phosphonic acid and salts thereof, acrylic polymer, citric acid and salts thereof, tartaric acid and salts thereof, zinc salts, alkaline earth metal salts and inorganic sulphate salts.

Preferably, the method further comprises a step of mixing an activator, the activator comprising one or more selected from the group consisting of a soluble hydroxide, a soluble silicate, a soluble carbonate and a soluble polyphosphate, preferably one or more selected from the group consisting of sodium hydroxide, potassium hydroxide, sodium silicate, potassium silicate, sodium carbonate, potassium carbonate, sodium polyphosphate and potassium polyphosphate, more preferably comprising sodium hydroxide and sodium silicate, or sodium silicate and sodium polyphosphate.

Preferably, the activator in a form of aqueous solution with a concentration of 0.5-10 mol/L is mixed with the modified siallite; more preferably, the solution of the activator comprises a soluble hydroxide with a concentration of 2-6 mol/L, preferably 3-5 mol/L; and/or a soluble silicate with a concentration of 1-6 mol/L, preferably 2-4 mol/L; and/or a soluble polyphosphate with a concentration of 3-7 mol/L, preferably 4-6 mol/L.

Preferably, a weight ratio of the solution of activator to the modified siallite is within a range of 0.3-0.8, more preferably 0.4-0.6.

A third aspect of the present disclosure provides a geopolymer material prepared with the method according to the second aspect of the present disclosure.

A fourth aspect of the present disclosure provides a use of the geopolymer material according to the first aspect or the third aspect of the present disclosure in the oilfield well cementation.

Due to the aforementioned technical schemes, the present disclosure produces the favorable effects as follows: the geopolymer material of the present disclosure has an appropriate initial setting time and final setting time under the activation of an activator, and can achieve well cementation at a higher temperature even without a retarder. Therefore, the curing properties (e.g., curing time) of the geopolymer can be controlled by merely adjusting the type and ratio of the geopolymers having different activities, such that the geopolymer material of the present disclosure can take performance advantages of geopolymer material while overcoming the hazards caused by its excessively rapid curing speed. In particular, the geopolymer material of the present disclosure has an initial setting time of 5-10 hours and a final setting time of 7-12 hours under the curing temperature, and can achieve a strength more than 10 MPa after 1 day of curing and a strength more than 21 MPa after 7 day of curing.

### BRIEF DESCRIPTION OF THE DRAWINGS

FIG. 1 illustrates an X-Ray Diffraction (XRD) spectrogram of the geopolymer material according to Example 1.

FIG. 2 illustrates an XRD spectrogram of uncalcined kaolin.

FIG. 3 illustrates an XRD spectrogram of a product from calcining kaolin at 600° C.

FIG. 4 shows an XRD spectrogram of a product from calcining kaolin at 750° C.

FIG. 5 shows the XRD spectrogram of a product from calcining kaolin at 850° C.

FIG. 6 shows an XRD spectrogram of a product from calcining kaolin at 900° C.

### DESCRIPTION OF THE PREFERRED EMBODIMENT

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point value of the various ranges, and the individual point values may be combined with one another to produce one or more new numerical ranges, which should be deemed have been specifically disclosed herein.

The present disclosure provides a geopolymer material comprising a modified siallite, the modified siallite has an aluminium content of 35 wt % or more and a silicon content of 40 wt % or more, on the basis of the total amount of the modified siallite and in terms of oxide; the geopolymer material has an initial setting time of 5-10 hours and a final setting time of 7-12 hours under at least one temperature within a range of 70-300° C.

In the present disclosure, “the geopolymer material has an initial setting time of 5-10 hours and a final setting time of 7-12 hours under at least one temperature within a range of 70-300° C.” refers to that the geopolymer material can reach an initial setting time of 5-10 hours and a final setting time of 7-12 hours during curing under at least one temperature within a range of 70-300° C.

During the process of measuring the initial setting time and final setting time, the activator and activation temperature may be appropriately selected according to the practical requirements, the requirements of the present disclosure can be met so long as the desired initial setting time and final setting time are finally obtained. As an activator used in preferred embodiments of the present disclosure, for example, it may be an aqueous solution comprising sodium hydroxide in an amount of 4 mol/L and sodium silicate in an amount of 3 mol/L, or an aqueous solution comprising sodium silicate in an amount of 6 mol/L and sodium tripolyphosphate in an amount of 5 mol/L.

In some preferred embodiments of the present disclosure, the geopolymer material has an initial setting time of 5-10 hours and a final setting time of 7-12 hours under at least one temperature within the ranges of 70-100° C., 100-150° C., 150-200° C., 200-250° C., or 250-300° C. The temperature range for achieving the above-mentioned initial setting time of 5-10 hours and a final setting time of 7-12 hours may be 50° C. or more, 60° C. or more, 70° C. or more, 80° C. or more, 90° C. or more, 100° C. or more, 110° C. or more, or 120° C. or more, and may be 300° C. or less.

According to the present disclosure, it is preferred in the disclosure that the modified siallite has an aluminium content of 35-47 wt %, preferably 40-46 wt %, and a silicon content of 40-55 wt %, preferably 45-54 wt %, on the basis of the total amount of the modified siallite and in terms of oxide. The aluminium content may be, for example, 35 wt %, 38 wt %, 40 wt %, 42 wt %, 45 wt %, or 46 wt %; the silicon content may be 40 wt %, 42 wt %, 45 wt %, 47 wt %, 50 wt %, 52 wt % or 55 wt %.

According to the present disclosure, it is preferred that a difference value between the final setting time and the initial setting time of the geopolymer material is within a range of 1-5 hours, more preferably 1-4 hours.

According to the present disclosure, it is preferred that the content of modified siallite in the geopolymer material is 55 wt % or more, more preferably 55-80 wt %. The modified sialillite may be calcined kaolin, for example. Furthermore, according to some preferred embodiments of the present disclosure, the geopolymer material may be composed of modified sialillite only, and may be used in combination with an activator as desired. According to other preferred embodiments of the present disclosure, the geopolymer material may consist of modified sialillite and an activator; the activator and the modified siallite are stored separately and mixed when in use.

According to the present disclosure, the geopolymer material has a strength above 20 MPa, preferably between 20 and 50 MPa, after 7 days of curing.

In some preferred embodiments of the present disclosure, the geopolymer material comprises at least two of a first geopolymer, a second geopolymer, a third geopolymer and a fourth geopolymer. The times required for curing the first geopolymer, the second geopolymer, the third geopolymer and the fourth geopolymer are decreased sequentially under the action of an activator. Therefore, the geopolymers are also referred to as a potentially active geopolymer, a low-activity geopolymer, a medium-activity geopolymer and a high-activity geopolymer respectively in the present disclosure. In some embodiments of the present disclosure, the curing properties of the geopolymer can be controlled by adjusting the type and content of geopolymers in the geopolymer material; preferably, the curing properties include an initial setting time, a final setting time and the mechanical properties of the product obtained after the curing process.

Specifically, the first geopolymer has an initial setting time of 32 hours or more or cannot be measured, and a final setting time cannot be measured; the second geopolymer has an initial setting time of 25 hours or more and less than 32 hours, and a final setting time of 60 hours or more or cannot be measured; the third geopolymer has an initial setting time of 8 hours or more and less than 25 hours, and a final setting time of 15 hours or more and less than 60 hours; the fourth geopolymer has an initial setting time of 2.5 hours or more and less than 8 hours, and a final setting time of 3 hours or more and less than 15 hours, under the activation conditions consisting of using an aqueous solution comprising sodium hydroxide in an amount of 4 mol/L and sodium silicate in an amount of 3 mol/L as an activator at 50° C., with a weight ratio of the activator and the geopolymer material being 0.5.

In the present disclosure, “an initial setting time cannot be measured” means that the geopolymer cannot solidify to a consistency of 100 Bc under the corresponding activation conditions; and “a final setting time cannot be measured” means that the geopolymer cannot solidify to a strength of 3.5 MPa under the corresponding activation conditions. The specific measurement methods for the initial setting time and the final setting time are set forth in the examples below.

In some preferred embodiments of the present disclosure, the first geopolymer, the second geopolymer, the third geopolymer and the fourth geopolymer are kaolin calcined at different temperatures, respectively.

Kaolin has a layered silicate structure, the layers are combined through the Van der Waals bonds therebetween, wherein the ions OH⁻ bond firmly. Its crystal structural units are composed of silicon-oxygen tetrahedra and aluminum-oxygen octahedra, which are laminated and stacked according to a ratio through the common oxygen atoms. In the Kaolin having such a crystal structure, the silicon and aluminum atoms are confined in crystal lattices, thus the atoms lack chemical activity, do not participate in the hydration reaction and have no cementitious properties. However, when kaolin is heated in air, it undergoes several structural changes when kaolin is heated to about 600° C., the layered structure of kaolin is disrupted by dehydration, so as to form a transition phase metakaolin with cementitious property and poor crystallinity. The metakaolin formed from kaolin calcined at different temperatures has various degrees of molecular alignment irregularities, and exhibits different thermodynamic metastable states, thus it is an ideal feedstock for performing a cascade curing reaction of geopolymer.

The kaolin in the present disclosure may comprise the following ingredients in weight percentage, for example, Al₂O₃≥35%, 40%≤SiO₂≤49%, Fe₂O₃≤1%, K₂O+Na₂O≤0.70%. The balance is mainly constitution water.

Preferably, the calcination temperatures of geopolymers are as follows, respectively:
(i) The calcination temperature of the first geopolymer is not higher than 600° C. or higher than 950° C. In some specific embodiments, the calcination temperature of the first geopolymer may be 100° C., 150° C., 200° C., 250° C., 300° C., 350° C., 400° C., 450° C., 500° C., 550°° C., 600° C., 980° C., or 1,100° C.
(ii) The calcination temperature of the second geopolymer is above 600° C. and not higher than 650° C., or above 850° C. and not higher than 950° C. In some specific embodiments, the calcination temperature of the second geopolymer may be 620° C., 650° C., 880° C., 900° C., or 950° C.
(iii) The calcination temperature of the third geopolymer is above 650° C. and not higher than 700° C., or above 750° C. and not higher than 850° C. In some specific embodiments, the calcination temperature of the third geopolymer may be 680° C., 700° C., 780° C., 800° C., or 850° C.
(iv) The calcination temperature of the fourth geopolymer is above 700° C. and not higher than 750° C.

In some specific embodiments, the calcination temperature of the fourth geopolymer may be 710° C., 720° C., 730° C., 740° C., or 750° C.

In some preferred embodiments of the present disclosure, the calcination time is within a range of 1.5-2.5 hours, preferably 1.8-2.2 hours, and may be 2 hours for example.

By cooperating with the above-mentioned geopolymers, the curing time of the geopolymer material in the present disclosure is reasonable and controllable, and the cascade reaction sequence is clear. The ingredients are matched with each other, wherein the ingredients with low activity ensure development of later strength, and the ingredients with high activity provide early strength support. The ingredients are evenly distributed in the geopolymer system, and can be uniformly cured.

In some specific embodiments of the present disclosure, the geopolymer material has an initial setting time of 5-10 hours and a final setting time of 7-12 hours under the temperature ranges of 70-300° C. The composition of the geopolymer material may be any one of the following options (1)-(8) in terms of parts by weight:
(1) 70-80 parts by weight of a third geopolymer and 70-80 parts by weight of a fourth geopolymer.

With the composition of the option (1) mentioned above, the obtained geopolymer material has an initial setting time of 5-7 hours and a final setting time of 7-10 hours under a temperature range of 70-100° C.
(2) 40-60 parts by weight of a second geopolymer, 90-110 parts by weight of a third geopolymer, and 8-12 parts by weight of a fourth geopolymer. With the composition of the option (2) mentioned above, the obtained geopolymer material has an initial setting time of 6-9 hours and a final setting time of 7-11 hours under a temperature range of 70-200° C.
(3) 40-60 parts by weight of a first geopolymer and 90-110 parts by weight of a third geopolymer.

With the composition of the option (3) mentioned above, the obtained geopolymer material has an initial setting time of 9-10 hours and a final setting time of 10-12 hours under a temperature higher than 200° C. and not higher than 300° C.
(4) 40-60 parts by weight of a second geopolymer and 70-90 parts by weight of a third geopolymer.

With the composition of the option (3) mentioned above, the obtained geopolymer material has an initial setting time of 7-10 hours and a final setting time of 10-12 hours under a temperature higher than 200° C. and not higher than 300° C.
(5) 90-110 parts by weight of a first geopolymer and 8-12 parts by weight of a third geopolymer.
(6) 90-110 parts by weight of a second geopolymer and 15-25 parts by weight of a third geopolymer.

With the composition of the option (5) or (6) mentioned above, the obtained geopolymer material has an initial setting time of 6-9 hours and a final setting time of 7-12 hours under a temperature higher than 200° C. and not higher than 300° C.
(7) 40-60 parts by weight of a second geopolymer and 90-110 parts by weight of a third geopolymer.
(8) 40-60 parts by weight of a first geopolymer and 90-110 parts by weight of a fourth geopolymer.

With the composition of the option (7) or (8) mentioned above, the obtained geopolymer material has an initial setting time of 5-9 hours and a final setting time of 7-11 hours under the temperature range of 70-200° C.

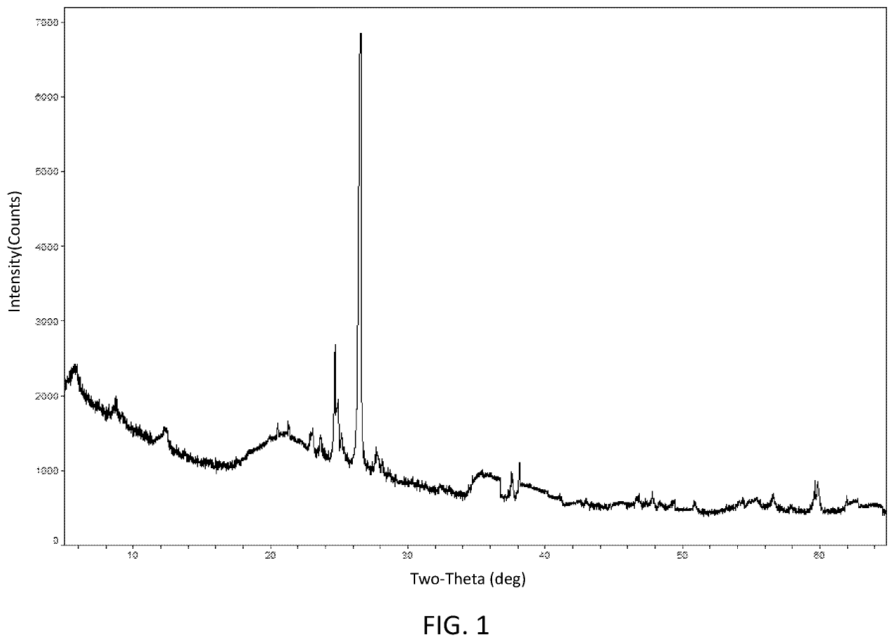

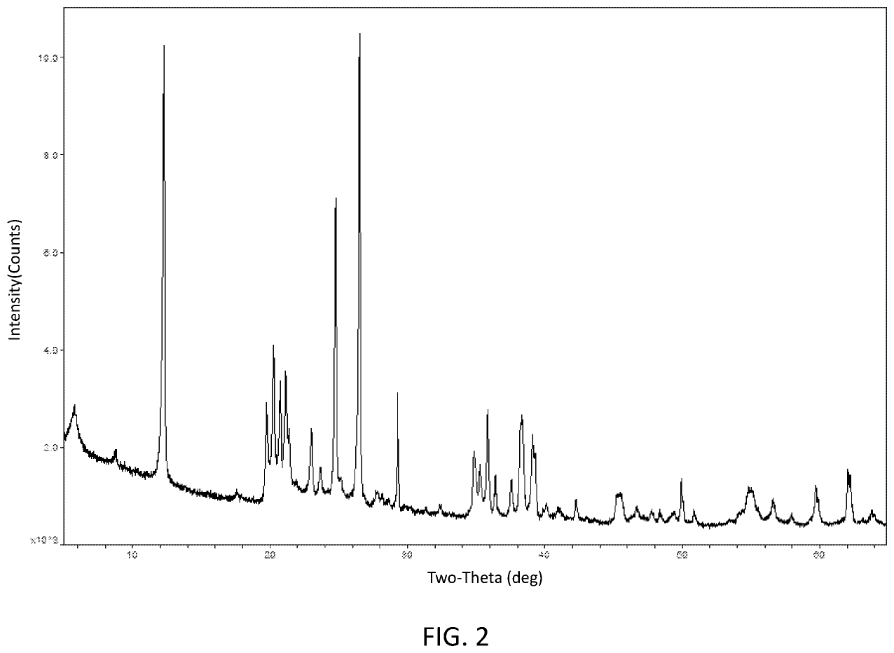

In some preferred embodiments of the present disclosure, an XRD spectrogram of the geopolymer material illustrates a crystalline characteristic peak and an amorphous characteristic peak when 2θ is within a range of 15-30°. As shown in FIG. 1, an XRD spectrogram of the geopolymer material in the present disclosure illustrates a crystalline characteristic peak and an amorphous characteristic peak when 2θ is within a range of 15-30°. In the present disclosure, the modified siallite is defined relative to unmodified siallite (e.g. uncalcined kaolin), an XRD spectrogram of the unmodified siallite illustrates crystalline characteristic peaks when 2θ is within a range of 15-30°; as shown in FIG. 2, the crystalline characteristic peaks are all sharp peaks.

The Si dissolution ratio of the calcinated geopolymers may be as follows: the first geopolymer has a Si dissolution ratio of 0.2 or less, the second geopolymer has a Si dissolution ratio of more than 0.2and 0.51 or less, the third geopolymer has a Si dissolution ratio of more than 0.51 and 0.82 or less, and the fourth geopolymer has a Si dissolution ratio of more than 0.82 and 1 or less.

According to the present disclosure, the geopolymer material has a Si dissolution ratio greater than 0.2, preferably within a range of 0.5-1, for example, the Si dissolution ratio may be within a range 0.5-0.8, 0.6-0.95 or 0.8-1. In contrast, the Si dissolution ratio of the unmodified silica (uncalcined kaolin) is only 0.005 or so.

In some preferred embodiments of the present disclosure, the geopolymer material further comprises an activator comprising one or more selected from the group consisting of a soluble hydroxide, a soluble silicate, a soluble carbonate and a soluble polyphosphate, preferably one or more selected from the group consisting of sodium hydroxide, potassium hydroxide, sodium silicate, potassium silicate, sodium carbonate, potassium carbonate, sodium polyphosphate and potassium polyphosphate, more preferably comprising sodium hydroxide and sodium silicate, or sodium silicate and sodium polyphosphate; the activator and the modified siallite are stored separately and mixed when in use. Wherein the soluble polyphosphate may be tripolyphosphate and/or pentapolyphosphate. As some preferred embodiments of the present disclosure, the activator comprises a hydroxide (preferably sodium hydroxide), and a silicate (preferably sodium silicate). As other preferred embodiments of the present disclosure, the activator comprises a silicate (preferably sodium silicate), and a polyphosphate (preferably sodium polyphosphate).

In some preferred embodiments of the present disclosure, the activator in a form of aqueous solution with a concentration of 0.5-10 mol/L is mixed with the modified siallite preferably 1-8 mol/L. As the activator containing a soluble hydroxide, a soluble silicate and/or a polyphosphate, it is preferable that the solution of the activator comprises a soluble hydroxide with a concentration of 2-6 mol/L, preferably 2-6 mol/L, such as 4 mol/L, and/or a soluble silicate with a concentration of 1-6 mol/L, preferably 2-4 mol/L, such as 4 mol/L, and/or a polyphosphate with a concentration of 3-7 mol/L, preferably 4-6 mol/L, such as 5 mol/L.

In some preferred embodiments of the present disclosure, a weight ratio of the solution of activator to the modified siallite is within a range of 0.3-0.8, preferably 0.4-0.6.

According to some preferred embodiments of the present disclosure, the geopolymer material may be composed of modified siallite and an activator. The activator and the modified siallite are stored separately and mixed when in use.

Given that the geopolymer materials provided by the present disclosure can obtain the desired curing time (including an initial setting time and a final setting time) and curing strength by adjusting the type and ratio of geopolymers, the use requirements can be met without appending an additional retarder. In the present disclosure, a retarder refers to an additive for extending the curing time of the geopolymer material. Whereas the geopolymer materials in the prior art typically require the addition of 10-20 wt % of a retarder relative to the total amount of geopolymer material, in order to inhibit and retard the curing process of the geopolymer material to meet the application requirements of operation, the aforementioned mode of adding a retarder typically can only meet the operational requirements at a temperatures below 60° C.

In the present disclosure, the geopolymer material does not include a retarder; the retarder is one or more selected from the group consisting of lignosulfonate and derivatives thereof, saccharides and derivatives thereof, boric acid and salts thereof, phosphoric acid and salts thereof, phosphonic acid and salts thereof, acrylic polymer, citric acid and salts thereof, tartaric acid and salts thereof, zinc salts, alkaline earth metal salts and inorganic sulphate salts. Wherein the saccharide and derivatives thereof may be calcium saccharide, gluconate, cellulose and derivatives thereof (e.g., carboxymethylhydroxyethylcellulose); boric acid and salts thereof can be boric acid, borax, etc.; phosphonic acid and salts thereof may be hydroxyethylidene diphosphonic acid, etc.; acrylic polymer may be 2-acrylamido-2-methylpropanesulfonic acid (AMPS) and 2-acrylamido-2-methylpropanesulfonic acid/acrylic acid (AMPS/AA), etc.

A second aspect of the present disclosure relates to a method of preparing geopolymer material comprising the step of preparing a geopolymer material by calcining kaolin at different temperatures to obtain at least two modified siallites, respectively, and then mixing the obtained at least two modified siallites.

In some preferred embodiments of the present disclosure, the at least two modified siallites are at least two of a first geopolymer, a second geopolymer, a third geopolymer and a fourth geopolymer. The calcination temperature, calcination time and matching ratio of the first geopolymer, the second geopolymer, the third geopolymer and the fourth geopolymer herein are the same as those for the first aspect, the content will not be repeated here. The method according to the second aspect of the present disclosure can be used for preparing geopolymer material of the first aspect.

In some preferred embodiments of the present disclosure, the method further comprises a step of mixing an activator, the activator may comprise one or more selected from the group consisting of a soluble hydroxide, a soluble silicate, a soluble carbonate and a soluble polyphosphate, preferably one or more selected from the group consisting of sodium hydroxide, potassium hydroxide, sodium silicate, potassium silicate, sodium carbonate, potassium carbonate, sodium polyphosphate and potassium polyphosphate. Wherein the soluble polyphosphate may be tripolyphosphate and/or pentapolyphosphate. As some preferred embodiments of the present disclosure, the activator comprises a hydroxide (preferably sodium hydroxide), and a silicate (preferably sodium silicate). As other preferred embodiments of the present disclosure, the activator comprises a silicate (preferably sodium silicate), and a polyphosphate (preferably sodium polyphosphate).

In some preferred embodiments of the present disclosure, the activator in a form of aqueous solution with a concentration of 0.5-10 mol/Lis mixed with the modified siallite, preferably 1-8 mol/L. As the activator containing a soluble hydroxide, a soluble silicate and/or a polyphosphate, it is preferable that the solution of the activator comprises a soluble hydroxide with a concentration of 2-6 mol/L, preferably 2-6 mol/L, such as 4 mol/L, and/or a soluble silicate with a concentration of 1-6 mol/L, preferably 2-4 mol/L, such as 4 mol/L, and/or a polyphosphate with a concentration of 3-7 mol/L, preferably 4-6 mol/L, such as 5 mol/L.

In some preferred embodiments of the present disclosure, a weight ratio of the solution of activator to the modified siallite is within a range of 0.3-0.8, preferably 0.4-0.6.

In some preferred embodiments of the method, the method does not include the step of adding a retarder, the retarder is one or more selected from the group consisting of lignosulfonate and derivatives thereof, saccharides and derivatives thereof, boric acid and salts thereof, phosphoric acid and salts thereof, phosphonic acid and salts thereof, acrylic polymer, citric acid and salts thereof, tartaric acid and salts thereof, zinc salts, alkaline earth metal salts and inorganic sulphate salts. Wherein the saccharide and derivatives thereof may be calcium saccharide, gluconate, cellulose and derivatives thereof (e.g., carboxymethylhydroxyethylcellulose); boric acid and salts thereof can be boric acid, borax, etc.; phosphonic acid and salts thereof may be hydroxyethylidene diphosphonic acid, etc.; acrylic polymer may be 2-acrylamido-2-methylpropanesulfonic acid (AMPS) and 2-acrylamido-2-methylpropanesulfonic acid/acrylic acid (AMPS/AA), etc.

A third aspect of the present disclosure provides a geopolymer material prepared with the method according to the second aspect mentioned above.

A fourth aspect of the present disclosure provides a use of the geopolymer material according to the first aspect and the geopolymer material prepared with the method according to the second aspect of the present disclosure in the oilfield well cementation.

By using the geopolymer material of the present disclosure, it is possible to obtain an initial setting time of 5-10 hours and a final setting time of 7-12 hours under the curing temperature, a strength after curing for 1 day being 12 MPa or more, and a strength after curing for 7 days being 21 MPa or more, thus the geopolymer material can be widely used in oilfield well cementation.

The present disclosure will be described in detail below with reference to examples. Unless otherwise specified, the term “parts” refers to the parts by weight in the above and following examples in the present disclosure.

In the present disclosure, the compressive strength was tested with reference to the method stipulated in the national standard GB/T19139-2012 of China.

The test method of initial setting time: a high-temperature and high-pressure thickener (the high-temperature and high-pressure thickener with a model Chandler 8240 manufactured by the Chandler corporation in USA) was used for testing under the test conditions of atmospheric pressure and corresponding temperature, the time required from when the geopolymer began to cure (i.e. when the activator was added) to the point where the consistency of the API standard thickening curve reached 100 Bc was denoted as the initial setting time.

The test method of final setting time: a high-temperature and high-pressure thickener (the high-temperature and high-pressure thickener with a model Chandler 8240 manufactured by the Chandler corporation in USA) was used for testing under the test conditions of atmospheric pressure and corresponding temperature, the time required from when the geopolymer began to cure to the point where the measured ultrasonic intensity reached 3.5 MPa was denoted as the final setting time. The Si dissolution ratio was measured by the ion dissolution method, the measurement is specifically performed with the following method:

41.667 g of analytically pure sodium hydroxide particles was weighted and placed in a polytetrafluoreothylene (PTFE) beaker, water was added to dissolve the sodium hydroxide particles and the solution had a constant volume of 500 ml, and formulated into a sodium hydroxide solution with a concentration of 2 mol/L, which was placed for 24 h and waited for use.

Prior to testing, the prepared sodium hydroxide solution was subjected to heat preservation at 80° C.; during the testing process, 0.1 g of the material to be tested was weighted and placed in the PTFE beaker along with 100 g of the sodium hydroxide solution after the heat preservation, the beaker was placed in the water bath condition of 80° C. and subjected to stirring and heat preservation for 3 h, the beaker mouth shall be covered by a membrane during the testing process to prevent moisture dissipation;

The reaction solution was withdrawn when the time of stirring the solution and heat preservation reached 3 hours, the solution was filtered with a filter membrane of 0.22 μm, the filtrate was then diluted by 50 times by using dilute nitric acid solution with a concentration of 2%, the concentration of silicon element in the diluted solution was measured by using an Inductively Coupled Plasma-Optical Emission Spectrometer (ICP-OES) apparatus, and the Si dissolution rate of the material to be tested=dissolution rate at the corresponding calcination temperature/dissolution rate at the calcination temperature of 750° C.

Preparation Example: preparation of geopolymers with different activities

A heavy-temperature tubular furnace was used for calcining and activating a raw material kaolin (which was composed of the following ingredients by weight: Al₂O₃ 36%, SiO₂ 43%, Fe₂O₃ 0.5%, K₂O 0.13%, Na₂O 0.01%, the balance was mainly constitution water) of geopolymer at different temperatures to form geopolymers with different activities. The calcination method was carried out by calcination in air for two hours and then cooling down. The calcination temperature, Si dissolution rate and activity grading were shown in Table 1, respectively. The weight loss after calcination was evaluated by the thermal weight loss experiment and the weighting with a balance, the weight loss was illustrated in Table 1.

TABLE 1

| | Condition | Condition | Condition | Condition | Condition | Condition | Condition | Condition |
|---|---|---|---|---|---|---|---|---|
| | 1 | 2 | 3 | 4 | 5 | 6 | 7 | 8 |
| Calcination | 600 | 650 | 700 | 750 | 800 | 840 | 900 | 960 |
| temperature, ° C. | | | | | | | | |
| Weight loss | 10.6 | 11.2 | 14.5 | 15.7 | 16.8 | 18.5 | 19.3 | 20.1 |
| ratio, % | | | | | | | | |
| Si dissolution | 0.20 | 0.51 | 0.82 | 1.00 | 0.63 | 0.53 | 0.33 | 0.17 |
| rate | | | | | | | | |
| Activity grading | Potentially | Low | Medium | High | Medium | Medium | Low | Potentially |
| | active | activity | activity | activity | activity | activity | activity | active |

The activity grading criteria for the geopolymers in the above Table 1 was shown in Table 2 below.

TABLE 2

| Activity grading | Calcination temperature |
|---|---|
| Potentially active | Calcination temperature ≤600° C. or >950° C. |
| Low activity | 600° C.< Calcination temperature ≤650° C., |
| | or 850° C.< Calcination temperature ≤950° C. |
| Medium activity | 650° C.< Calcination temperature ≤700° C., |
| | or 750° C.< Calcination temperature ≤850° C. |
| High activity | 700° C.< Calcination temperature ≤750° C. |

### Example 1

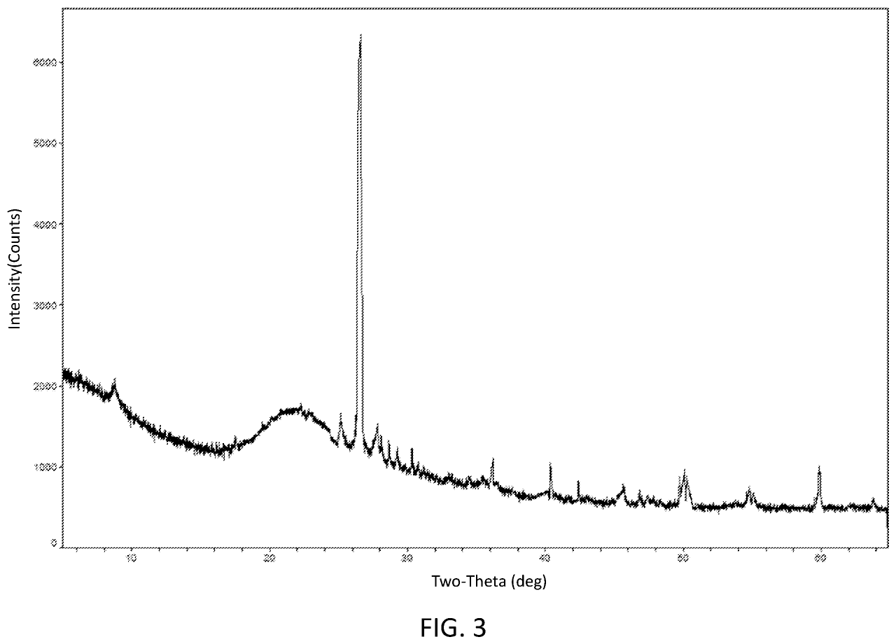

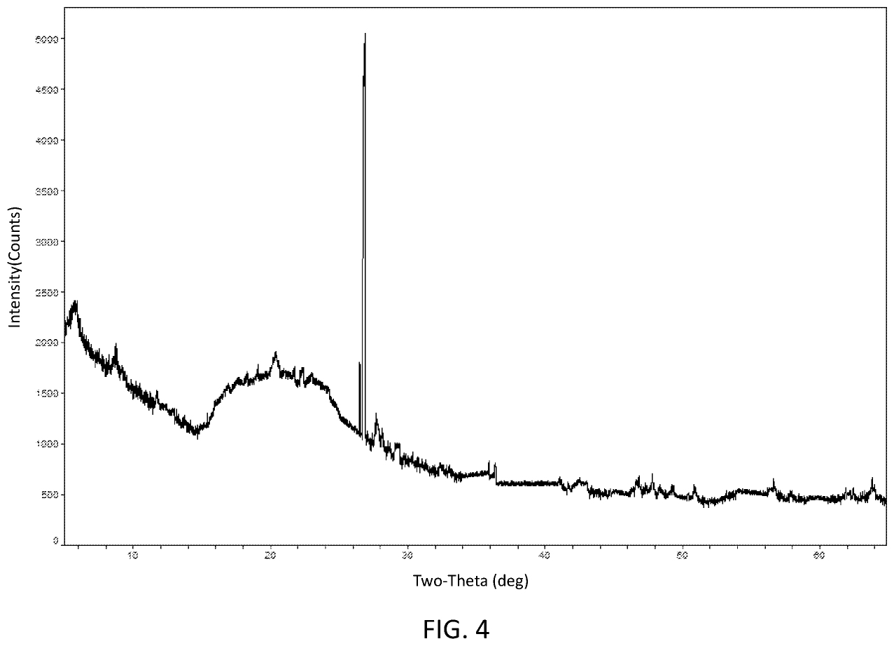

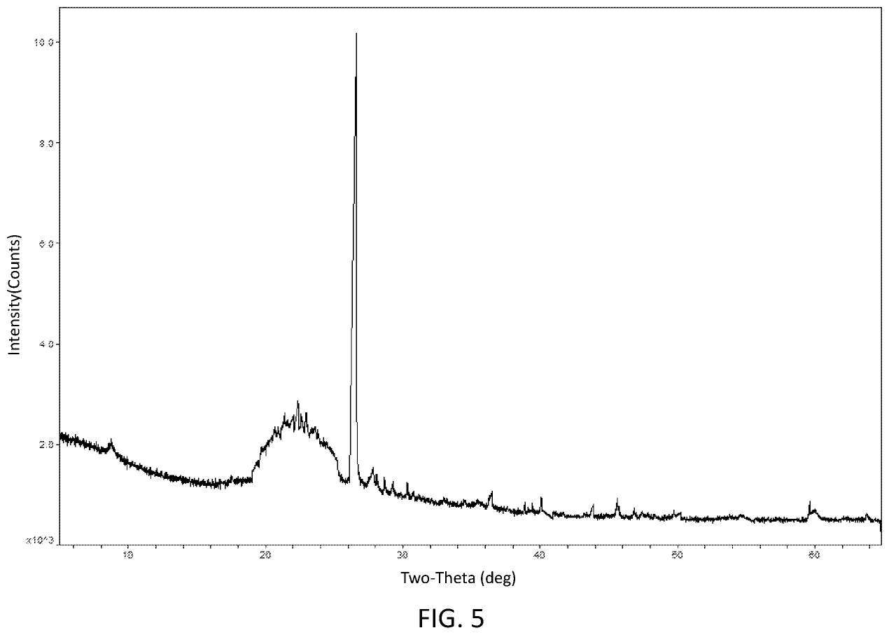

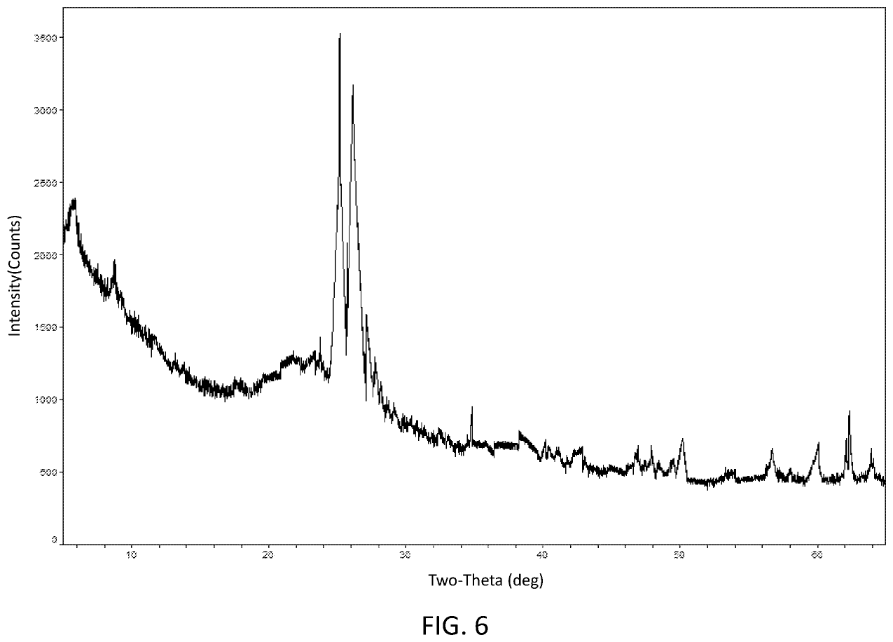

75 parts of a medium-activity geopolymer (condition 3) and 75 parts of a high-activity geopolymer (condition 4) prepared by the Preparation Example were weighted proportionally, and mixed uniformly to obtain a geopolymer material. The XRD spectrogram of the geopolymer material was shown in FIG. 1, the Si dissolution ratio was 0.9. Furthermore, the XRD spectrograms of the uncalcined kaolin and the calcined kaolin products at 600° C., 750° C., 800° C. and 900° C. were shown in FIG. 2, FIG. 3, FIG. 4, FIG. 5 and FIG. 6, respectively.

An activation experiment was carried out by using an aqueous solution containing sodium hydroxide in an amount of 4 mol/L and sodium silicate in an amount of 3 mol/L as the activator, a weight ratio of the activator to the geopolymer material was 0.5, the initial setting time and the final setting time of the produced geopolymer material at different curing temperatures were shown in Table 3. The strength test conditions comprised the curing for 7 days at a predetermined temperature, the strength measurement results for geopolymer material after curing for 1 day and 7 days were shown in Table 4.

### Example 2

50 parts of the low-activity geopolymer (condition 2), 100 parts of the medium-activity geopolymer (condition 3) and 10 parts of the high-activity geopolymer produced by the Preparation Examples were weighted proportionally, and mixed uniformly to obtain a geopolymer material.

The initial/final setting time of the geopolymer material and the strength after curing for 1 day and 7 days were measured according to the same method as in Example 1, the results were shown in Table 3 and Table 4, respectively.

### Example 3

100 parts of the potentially active geopolymer (condition 1) and 10 parts of the medium-activity geopolymer (condition 3) produced by the Preparation Examples were weighted proportionally, and mixed uniformly to obtain a geopolymer material.

The initial/final setting time of the geopolymer material and the strength after curing for 1 day and 7 days were measured according to the same method as in Example 1, the results were shown in Table 3 and Table 4, respectively.

### Example 4

50 parts of the potentially active geopolymer (condition 1) and 100 parts of the medium-activity geopolymer (condition 3) produced by the Preparation Examples were weighted proportionally, and mixed uniformly to obtain a geopolymer material.

The initial/final setting time of the geopolymer material and the strength after curing for 1 day and 7 days were measured according to the same method as in Example 1, the results were shown in Table 3 and Table 4, respectively.

### Example 5

50 parts of the low-activity geopolymer (condition 2) and 80 parts of the medium-activity geopolymer (condition 3) produced by the Preparation Examples were weighted proportionally, and mixed uniformly to obtain a geopolymer material.

The initial/final setting time of the geopolymer material and the strength after curing for 1 day and 7 days were measured according to the same method as in Example 1, the results were shown in Table 3 and Table 4, respectively.

### Example 6

100 parts of the low-activity geopolymer (condition 2) and 20 parts of the medium-activity geopolymer (condition 3) produced by the Preparation Examples were weighted proportionally, and mixed uniformly to obtain a geopolymer material.

The initial/final setting time of the geopolymer material and the strength after curing for 1 day and 7 days were measured according to the same method as in Example 1, the results were shown in Table 3 and Table 4, respectively.

### Example 7

50 parts of the low-activity geopolymer (condition 2) and 100 parts of the medium-activity geopolymer (condition 3) produced by the Preparation Examples were weighted proportionally, and mixed uniformly to obtain a geopolymer material.

The initial/final setting time of the geopolymer material and the strength after curing for 1 day and 7 days were measured according to the same method as in Example 1, except that an aqueous solution containing sodium silicate in an amount of 6 mol/L and sodium tripolyphosphate in an amount of 5 mol/L was used as the activator, the results were shown in Table 3 and Table 4, respectively.

### Example 8

50 parts of the potentially active geopolymer (condition 1) and 100 parts of the high-activity geopolymer (condition 4) produced by the Preparation Examples were weighted proportionally, and mixed uniformly to obtain a geopolymer material.

The initial/final setting time of the geopolymer material and the strength after curing for 1 day and 7 days were measured according to the same method as in Example 7, the results were shown in Table 3 and Table 4, respectively.

### Comparative Example 1

50 parts of the potentially active geopolymer (condition 1) prepared in Example 1 was weighted. The initial/final setting time of the geopolymer material and the strength after curing for 1 day and 7 days were measured according to the same method as in Example 1, the results were shown in Table 3 and Table 4, respectively.

### Comparative Example 2

150 parts of the low-activity geopolymer (condition 2) prepared in Example 1 was weighted. The initial/final setting time of the geopolymer material and the strength after curing for 1 day and 7 days were measured according to the same method as in Example 1, the results were shown in Table 3 and Table 4, respectively.

### Comparative Example 3

150 parts of the medium-activity geopolymer (condition 3) prepared in Example 1 was weighted. The initial/final setting time of the geopolymer material and the strength after curing for 1 day and 7 days were measured according to the same method as in Example 1, the results were shown in Table 3 and Table 4, respectively.

### Comparative Example 4

150 parts of the high-activity geopolymer (condition 4) prepared in Example 1 was weighted. The initial/final setting time of the geopolymer material and the strength after curing for 1 day and 7 days were measured according to the same method as in Example 1, the results were shown in Table 3 and Table 4, respectively.

Comparative Example 5

The geopolymer material was prepared according to the same method as in Example 2, except that a weight ratio of the activator and the geopolymer material was 1. The initial/final setting time of the geopolymer material and the strength after curing for 1 day and 7 days were measured according to the same method as in Example 2, the results were shown in Table 3 and Table 4, respectively.

TABLE 3
initial setting time/final setting time (h) of geopolymers under different temperatures

| | 50° C. | | 70° C. | | 100° C. | | 200° C. | | 300° C. | |
|---|---|---|---|---|---|---|---|---|---|---|
| | Initial | Final | Initial | Final | Initial | Final | Initial | Final | Initial | Final |
| No. | setting | setting | setting | setting | setting | setting | setting | setting | setting | setting |
| Example 1 | 7 | 9 | 6.5 | 8.4 | 6 | 7.5 | 5.8 | 6.5 | 4 | 4.6 |
| Example 2 | 8.3 | 9.5 | — | — | — | — | 6.3 | 7.5 | 4.5 | 5 |
| Example 3 | 18 | 22 | — | — | — | — | 12.5 | 15 | 9 | 12 |
| Example 4 | 9 | 11 | — | — | — | — | 5 | 9 | 3 | 3.5 |
| Example 5 | 16 | 19 | — | — | — | — | 9 | 12 | 8 | 11 |
| Example 6 | 15 | 17 | — | — | — | — | 11 | 14 | 6 | 7 |
| Example 7 | 7.5 | 9 | 7.3 | 8.8 | 7 | 8.5 | 6 | 7.5 | 4.3 | 5 |
| Example 8 | 8.5 | 11 | 8.1 | 10.6 | 7 | 10 | 5 | 9 | 2.5 | 3.3 |
| Comparative | 32 | * | — | — | — | — | 22 | 28 | 13 | 17 |
| Example 1 | | | | | | | | | | |
| Comparative | 25 | 60 | — | — | — | — | 13 | 18 | 9 | 13 |
| Example 2 | | | | | | | | | | |
| Comparative | 8 | 15 | — | — | — | — | 3 | 5 | 2 | 3 |
| Example 3 | | | | | | | | | | |
| Comparative | 2.5 | 3 | — | — | — | — | 1 | 1.5 | 0.5 | 1 |
| Example 4 | | | | | | | | | | |
| Comparative | 3.5 | 5 | — | — | — | — | 2 | 3 | 1.5 | 2 |
| Example 5 | | | | | | | | | | |

In the table, “—” indicates that the time is not determined (as used herein), and “*” indicates that the time cannot be measured.

As can be seen from the experimental results illustrated in Table 3, the geopolymer materials of Examples 1-8 can be used for performing the cascade curing reaction by means of combining the ingredients with different activities, thereby controlling the curing time, meeting an initial setting time of 5-10 hours and a final setting time of 7-12 hours under the curing temperature within a range of 70-300° C., and meeting the requirements of well cementation operation. Wherein the Examples 1-2, 4, 5, and 7-8 are suitable for medium and high temperature well cementation (70≤temperature≤200° C.); the Examples 3, 5, and 6 are suitable for high and ultra-high temperature well cementation (200° C.<temperature<300° C.). The geopolymers of Comparative Examples 1-4have a single curing time (the curing time is excessively fast or too slow) because they contain only one active ingredient, thus the curing time is uncontrollable and unadjustable during the operation process. The geopolymer of Comparative Example 5 has an excessively rapid curing time because of the excess dosage of activator, which causes inconvenience for the operation.

TABLE 4

| | Strength after curing for 1 day | | | | |
|---|---|---|---|---|---|
| | under different temperatures (MPa) | | | | |
| No. | 50° C. | 70° C. | 100° C. | 200° C. | 300° C. |
| Example 1 | 18 | 19.5 | 21 | 29 | 34 |
| Example 2 | 12.3 | — | — | 18.4 | 22.9 |
| Example 3 | 9.2 | — | — | 18.7 | 21.6 |
| Example 4 | 15.9 | — | — | 16.5 | 21.3 |
| Example 5 | 12.1 | — | — | 16.2 | 22.2 |
| Example 6 | 11.1 | — | — | 20.2 | 25.2 |
| Example 7 | 12 | 13.8 | 16 | 20 | 26 |
| Example 8 | 10 | 12.5 | 14 | 17 | 23 |
| Comparative | — | — | — | — | 2 |
| Example 1 | | | | | |
| Comparative | 4 | — | — | 15 | 21 |
| Example 2 | | | | | |
| Comparative | 15 | — | — | 26 | 30 |
| Example 3 | | | | | |
| Comparative | 23 | — | — | 31.2 | 38 |
| Example 4 | | | | | |
| Comparative | 18 | — | — | 29.2 | 36.5 |
| Example 5 | | | | | |

TABLE 5

| | Strength after curing for 7 days | | | | |
|---|---|---|---|---|---|
| | under different temperatures (MPa) | | | | |
| No. | 50° C. | 70° C. | 100° C. | 200° C. | 300° C. |
| Example 1 | 34 | 35.5 | 38 | 44 | 48 |
| Example 2 | 27.3 | — | — | 38.4 | 26.9 |
| Example 3 | 23.2 | — | — | 25.7 | 37.6 |
| Example 4 | 36.9 | — | — | 26.5 | 20.3 |
| Example 5 | 27.1 | — | — | 39.2 | 21.2 |
| Example 6 | 20.1 | — | — | 26.2 | 36.2 |
| Example 7 | 30 | 31 | 33 | 49 | 53 |
| Example 8 | 24 | 26 | 29 | 44 | 56 |
| Comparative | 0.5 | — | — | 6 | 10 |
| Example 1 | | | | | |
| Comparative | 9 | — | — | 24 | 29 |
| Example 2 | | | | | |
| Comparative | 26 | — | — | 38 | 45 |
| Example 3 | | | | | |
| Comparative | 42.7 | — | — | 49.5 | 52.4 |
| Example 4 | | | | | |
| Comparative | 41 | — | — | 45 | 49.8 |
| Example 5 | | | | | |

As illustrated in Table 4 and Table 5, each of the geopolymers obtained in Examples 1-8 can obtain that the strength after curing for 1 day under the suitable temperature is 10 MPa or more, and the maximum is 25.2 MPa; the strength after curing for 7 days under the suitable temperature is 21 MPa or more, and the maximum is 49 MPa; in addition, the strength does not decline under the high temperature environment, but increases within certain ranges. This is the property unattainable for the conventional silicate well cementation materials.

1. A geopolymer material comprising a modified siallite, wherein the modified siallite has an aluminium content of 35 wt % or more and a silicon content of 40 wt % or more, on the basis of the total amount of the modified siallite and in terms of oxide; and the geopolymer material has an initial setting time of 5-10 hours and a final setting time of 7-12 hours under at least one temperature within a range of 70-300° C.

2. The geopolymer material according to claim 1, wherein the geopolymer material has an initial setting time of 5-10 hours and a final setting time of 7-12 hours under at least one temperature within the ranges of 70-100° C., 100-150° C., 150-200° C., 200-250° C., or 250-300° C.;
and/or, a difference value between the final setting time and the initial setting time of the geopolymer material is within a range of 1-5 hours.

3. The geopolymer material according to claim 1, wherein the geopolymer material does not contain a retarder, the retarder is one or more selected from the group consisting of lignosulfonate and derivatives thereof, saccharides and derivatives thereof, boric acid and salts thereof, phosphoric acid and salts thereof, phosphonic acid and salts thereof, acrylic polymer, citric acid and salts thereof, tartaric acid and salts thereof, zinc salts, alkaline earth metal salts and inorganic sulphate salts.

4. The geopolymer material according to claim 1, wherein the content of modified siallite in the geopolymer material is 55 wt % or more;
and/or, an XRD spectrogram of the geopolymer material illustrates a crystalline characteristic peak and an amorphous characteristic peak when 2θ is within a range of 15-30°; and/or, the geopolymer material has a Si dissolution ratio greater than 0.2.

5-6. (canceled)

7. The geopolymer material according to claim 1, wherein the geopolymer material comprises at least two of a first geopolymer, a second geopolymer, a third geopolymer and a fourth geopolymer; wherein the first geopolymer has an initial setting time of 32 hours or more or cannot be measured, and a final setting time cannot be measured;
the second geopolymer has an initial setting time of 25 hours or more and less than 32 hours, and a final setting time of 60 hours or more or cannot be measured; the third geopolymer has an initial setting time of 8 hours or more and less than 25 hours, and a final setting time of 15 hours or more and less than 60 hours; the fourth geopolymer has an initial setting time of 2.5 hours or more and less than 8 hours, and a final setting time of 3 hours or more and less than 15 hours, under the activation conditions consisting of using an aqueous solution comprising sodium hydroxide in an amount of 4 mol/L and sodium silicate in an amount of 3 mol/L as an activator at 50° C., with a weight ratio of the activator and the geopolymer material being 0.5.

8. The geopolymer material according to claim 7, wherein the first geopolymer, the second geopolymer, the third geopolymer and the fourth geopolymer are kaolin calcined at different temperatures, respectively.

9. The geopolymer material according to claim 8, wherein the calcination temperatures of geopolymers are as follows:
the calcination temperature of the first geopolymer is not higher than 600° C. or higher than 950° C.;
the calcination temperature of the second geopolymer is above 600° C. and not higher than 650° C., or above 850° C. and not higher than 950° C.;
the calcination temperature of the third geopolymer is above 650° C. and not higher than 700° C., or above 750° C. and not higher than 850° C.;
the calcination temperature of the fourth geopolymer is above 700° C. and not higher than 750° C.;
and/or, the calcination time is within a range of 1.5-2.5 hours.

10. The geopolymer material according to claim 7, wherein the geopolymer material comprise any one of the following geopolymers in terms of parts by weight:
(1) 70-80 parts of a third geopolymer and 70-80 parts of a fourth geopolymer;
(2) 40-60 parts of a second geopolymer, 90-110 parts of a third geopolymer, and 8-12 parts of a fourth geopolymer;
(3) 40-60 parts of a first geopolymer and 90-110 parts of a third geopolymer;
(4) 40-60 parts of a second geopolymer and 70-90 parts of a third geopolymer;
(5) 90-110 parts of a first geopolymer and 8-12 parts of a third geopolymer;
(6) 90-110 parts of a second geopolymer and 15-25 parts of a third geopolymer;
(7) 40-60 parts by weight of a second geopolymer and 90-110 parts by weight of a third geopolymer;
(8) 40-60 parts by weight of a first geopolymer and 90-110 parts by weight of a fourth geopolymer.

11. The geopolymer material according to claim 1, wherein the geopolymer material further comprises an activator comprising one or more selected from the group consisting of a soluble hydroxide, a soluble silicate, a soluble carbonate and a soluble polyphosphate, the activator and the modified siallite are stored separately and mixed when in use.

12. The geopolymer material according to claim 11, wherein the activator in a form of aqueous solution with a concentration of 0.5-10 mol/L is mixed with the modified siallite;
and/or, a weight ratio of the solution of activator to the modified siallite is within a range of 0.3-0.8.

13. The geopolymer material according to claim 12, wherein the solution of the activator comprises a soluble hydroxide with a concentration of 2-6 mol/L, and/or a soluble silicate with a concentration of 1-6 mol/L, and/or a soluble polyphosphate with a concentration of 3-7 mol/L; and/or, the weight ratio of the solution of activator to the modified siallite is within a range of 0.4-0.6.

14. A method of preparing geopolymer material comprising the step of preparing a geopolymer material by calcining kaolin at different temperatures separately to obtain at least two modified siallites, and then mixing the obtained at least two modified siallites.

15. The method according to claim 14, wherein the at least two modified siallites are at least two of a first geopolymer, a second geopolymer, a third geopolymer and a fourth geopolymer;
wherein the calcination temperatures of geopolymers are as follows:
the calcination temperature of the first geopolymer is not higher than 600° C. or higher than 950° C.;
the calcination temperature of the second geopolymer is above 600° C. and not higher than 650° C., or above 850° C. and not higher than 950° C.;
the calcination temperature of the third geopolymer is above 650° C. and not higher than 700° C., or above 750° C. and not higher than 850° C.;
the calcination temperature of the fourth geopolymer is above 700° C. and not higher than 750° C.;
and/or, the calcination time is within a range of 1.5-2.5 hours.

16. The method according to claim 14, wherein the method does not include a step of adding a retarder, the retarder is one or more selected from the group consisting of lignosulfonate and derivatives thereof, saccharides and derivatives thereof, boric acid and salts thereof, phosphoric acid and salts thereof, phosphonic acid and salts thereof, acrylic polymer, citric acid and salts thereof, tartaric acid and salts thereof, zinc salts, alkaline earth metal salts and inorganic sulphate salts.

17. The method according to claim 14, wherein the method further comprises a step of mixing an activator, the activator comprising one or more selected from the group consisting of a soluble hydroxide, a soluble silicate, a soluble carbonate and a soluble polyphosphate.

18. The method according to claim 16, wherein the activator in a form of aqueous solution with a concentration of 0.5-10 mol/L is mixed with the modified siallite;

19. The method according to claim 18, wherein the solution of the activator comprises a soluble hydroxide with a concentration of 2-6 mol/L, and/or a soluble silicate with a concentration of 1-6 mol/L, and/or a soluble polyphosphate with a concentration of 3-7 mol/L; and/or, a weight ratio of the solution of activator to the modified siallite is within a range of 0.3-0.8.

20. (canceled)

21. A method of cementing in oilfield well comprising the step of injecting the geopolymer material according to claim 1 into an oilfield well, and curing.

22. The geopolymer material according to claim 11, wherein the activator comprising one or more selected from the group consisting of sodium hydroxide, potassium hydroxide, sodium silicate, potassium silicate, sodium carbonate, potassium carbonate, sodium polyphosphate and potassium polyphosphate; and/or
the activator comprising sodium hydroxide and sodium silicate, or sodium silicate and sodium polyphosphate.

23. The method according to claim 17, wherein the activator comprising one or more selected from the group consisting of sodium hydroxide, potassium hydroxide, sodium silicate, potassium silicate, sodium carbonate, potassium carbonate, sodium polyphosphate and potassium polyphosphate; and/or
the activator comprising sodium hydroxide and sodium silicate, or sodium silicate and sodium polyphosphate.
